(19) United States
(12) Patent Application Publication
(10) Pub. No.: US 2008/0155295 A1
(43) Pub. Date: Jun. 26, 2008

(54) SYNCHRONIZATION CONTROL APPARATUS

(75) Inventors: Takeshi Tomizawa, Kanagawa (JP); Hidenori Matsuzaki, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/782,053

(22) Filed: Jul. 24, 2007

(30) Foreign Application Priority Data
Dec. 25, 2006 (JP) 2006-348312

(51) Int. Cl. G06F 1/12

(52) U.S. Cl. 713/375

(57) ABSTRACT

A synchronization control apparatus includes a first processing block that performs a first process and outputs a first signal upon completion of the first process, a second processing block that can change processing speed according to electric power supplied thereto, performs a second process associated with the first process out of synchronization with the first processing block, and outputs a second signal upon completion of the second process, a control unit that determines an amount of the electric power to be supplied to the second processing block according to time difference between an input of the first signal and an input of the second signal, and a supply unit that supplies the electric power in the amount determined to the second processing block.

### CROSS-REFERENCE TO RELATED APPLICATIONS

This application is based upon and claims the benefit of priority from the prior Japanese Patent Application No. 2006-348312, filed on Dec. 25, 2006; the entire contents of which are incorporated herein by reference.

### BACKGROUND OF THE INVENTION

1. Field of the Invention

The present invention relates to a synchronization control apparatus for an asynchronous circuit.

2. Description of the Related Art

Conventionally, a synchronous circuit design technology is employed in the field of electronic circuit design. According to the synchronous circuit design technology, electronic circuits are designed based on a combination of sequential circuits that are synchronized with a clock frequency. On the other hand, there is an asynchronous circuit design technology based on another signal such as a communication protocol without using the clock frequency. A device that realizes a predetermined function by combining a synchronous circuit and an asynchronous circuit generated by the technologies are widely used.

Various technologies have been proposed for the asynchronous circuit. For example, JP-A H5-265607 (KOKAI) discloses a technology that controls speed of a processing block designed as the asynchronous circuit by applying a voltage corresponding to a sufficiency level of a buffer in the processing block, thereby preventing data from overflowing from the buffer.

The technology described in JP-A H5-265607 (KOKAI), however, compensates for environmental changes such as changes in temperature, voltage, and the like only with the buffer, and therefore, the size of the buffer is redundant and the power consumption is high. Moreover, a control loop for controlling the processing block is closed, and relations with other circuits are not considered at all. Therefore, if there is temporal restriction such as synchronization of the processing speed in relation to an operation of other circuitry, the technology cannot be used.

### SUMMARY OF THE INVENTION

A synchronization control apparatus includes a first processing block that performs a first process and outputs a first signal upon completion of the first process, a second processing block that can change processing speed according to electric power supplied thereto, performs a second process associated with the first process out of synchronization with the first processing block, and outputs a second signal upon completion of the second process, a control unit that determines an amount of the electric power to be supplied to the second processing block according to time difference between an input of the first signal and an input of the second signal, and a supply unit that supplies the electric power in the amount determined to the second processing block.

### BRIEF DESCRIPTION OF THE DRAWINGS

FIG. 1 is a block diagram of a synchronization control apparatus according to a first embodiment of the present invention;

FIG. 2 is a block diagram of a power control unit shown in FIG. 1;

FIGS. 3A, 3B, and 3C are signal waveform diagrams according to the first embodiment;

FIGS. 4A and 4B are signal waveform diagrams according to the first embodiment;

FIG. 5 is a block diagram of a power control unit according to a first modification of the first embodiment;

FIG. 6 is a signal waveform diagram according to the first modification;

FIG. 7 is a block diagram of a controlled-voltage generating unit according to a second modification of the first embodiment;

FIG. 8 is a block diagram of a synchronization control apparatus according to a second embodiment of the present invention;

FIG. 9 is a block diagram of a power control unit shown in FIG. 8;

FIG. 10 is a signal waveform diagram indicative of a delay time;

FIGS. 11A, 11B, and 11C are signal waveform diagrams;

FIG. 12 is a block diagram of a power control unit according to a first modification of the second embodiment;

FIG. 13 is a signal waveform diagram indicative of a delay time;

FIG. 14 is a signal waveform diagram of a valid signal;

FIG. 15 is a block diagram of a frame processor;

FIG. 16 is a schematic of relations between time and one or both of voltage and power;

FIG. 17 is a block diagram of a synchronization control apparatus according to a third embodiment of the present invention;

FIG. 18 is a block diagram of a power control unit shown in FIG. 17;

FIG. 19 is a signal waveform diagram indicative of a delay time;

FIGS. 20A, 20B, and 20C are signal waveform diagrams;

FIG. 21 is a block diagram of a power control unit according to a first modification of the third embodiment;

FIG. 22 is a signal waveform diagram indicative of a delay time;

FIG. 23 is a signal waveform diagram of a valid signal; and

FIG. 24 is a block diagram of a de-spreading apparatus.

### DETAILED DESCRIPTION OF THE INVENTION

Exemplary embodiments of the present invention are explained below in detail with reference to the accompanying drawings.

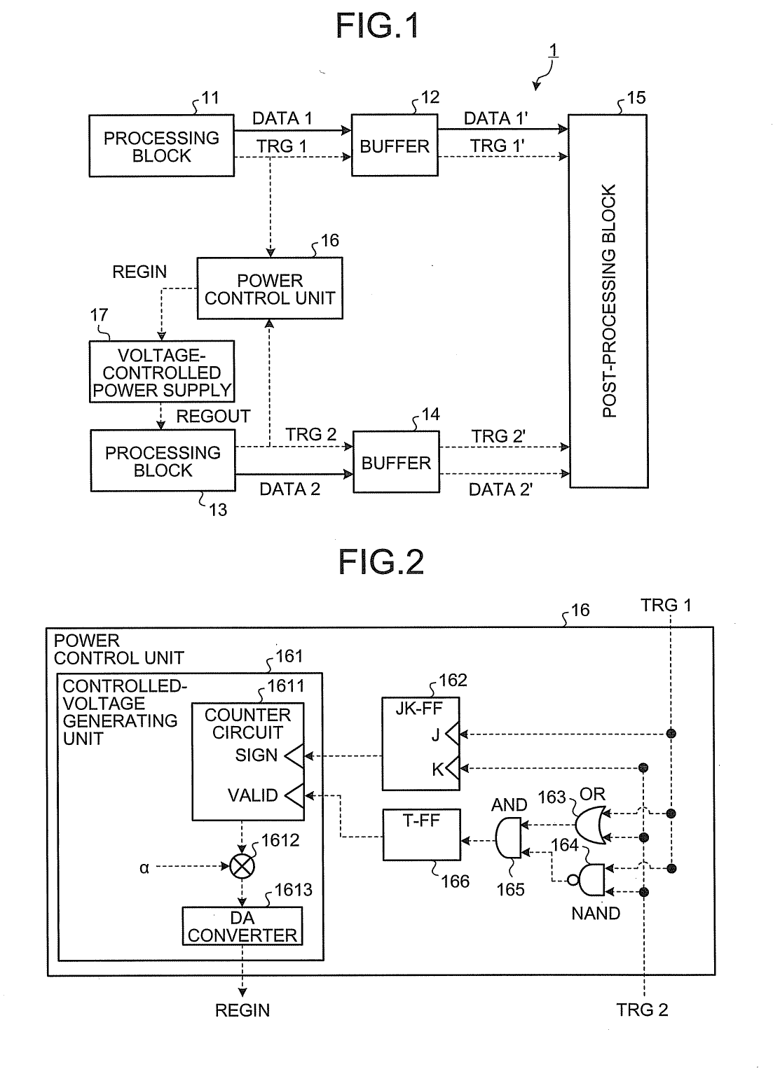

FIG. 1 is a block diagram of a synchronization control apparatus 1 according to a first embodiment of the present invention. As shown in FIG. 1, the synchronization control apparatus 1 includes a processing block 11, a buffer 12, a processing block 13, a buffer 14, a post-processing block 15, a power control unit 16, and a voltage-controlled power supply 17.

The processing block 11 includes one of a synchronous circuit and an asynchronous circuit. The processing block 11 performs a predetermined process on data, and generates DATA 1 as a result of the process. The processing block 11 outputs the DATA 1 to the buffer 12, and outputs a trigger signal TRG 1 to the buffer 12 and the power control unit 16. The TRG 1 indicates that the DATA 1 is updated new data.

The buffer 12 is a storage unit that includes a volatile recording medium. Upon receiving the TRG 1 from the processing block 11, the buffer 12 stores the DATA 1 received with the TRG 1 as DATA 1′ until it receives the next TRG 1. The buffer 12 outputs the trigger signal TRG 1′ to the post-processing block 15 every time the DATA 1′ is updated to inform the fact that a new DATA 1′ is stored in the buffer 12.

The processing block 13 includes an asynchronous circuit. The processing block 13 performs a predetermined process on data and generates DATA 2 as a result of the process. The processing block 13 outputs the DATA 2 to the buffer 14, and outputs a trigger signal TRG 2 to the buffer 14 and the power control unit 16. The TRG 2 indicates that the DATA 2 is new data.

The processing block 11 and the processing block 13 process different data; however, both data make a pair, and the post-processing block 15 performs a process based on a pair of the processed data, which are, for example, the DATA 1′ and DATA 2′.

According to the first embodiment, there is assumed to be a temporal restriction for the post-processing block 15 on the timing of inputting the pair of the processed data. Therefore, the data to be processed by the processing block 11 and the processing block 13 are temporally associated with operations of the processing block 11 and the processing block 13, and naturally related to synchronization between the processing block 11 and the processing block 13. The data to be processed are input from an external circuit (not shown) to each of the processing block 11 and the processing block 13 in units of data pairs.

The buffer 14 is a storage unit that includes a volatile recording medium. Upon receiving the TRG 2 from the processing block 13, the buffer 14 stores the DATA 2 received with the TRG 2 as DATA 2′ until it receives the next TRG 2. The buffer 14 outputs the trigger signal TRG 2′ to the post-processing block 15 every time the DATA 2′ is updated to inform the fact that a new DATA 2′ is stored in the buffer 14.

When both of the TRG 1′ and the TRG 2′ are updated, the post-processing block 15 acquires the DATA 1′ from the buffer 12 and the DATA 2′ from the buffer 14, and performs a predetermined process or operation based on the acquired data.

The power control unit 16 monitors the TRG 1 and the TRG 2, determines which one of the TRG 1 and the TRG 2 is updated earlier when both data are updated, and outputs a control signal REGIN corresponding to the time difference to the voltage-controlled power supply 17. The determination is made based on the trigger signals, the TRG 1 and the TRG 2, that are input upon completion of processing the data related to the synchronization between the processing block 11 and the processing block 13.

The voltage-controlled power supply 17 supplies power to the processing block 13 based on the control signal REGIN. The supplied power has a voltage REGOUT specified by the control signal REGIN. Though the voltage REGOUT specified by the control signal REGIN will be described later, it is noted here that the REGOUT is such that a time difference between the TRG 1 and the TRG 2 is a predetermined time.

The power control unit 16 is described below in detail. According to the first embodiment, the TRG 1 and the TRG 2 respectively output from the processing block 11 and the processing block 13 are each in the form of a sporadic pulse signal with a pulse width within a reference clock time. The TRG 1 and the TRG 2 serve as a signal that indicates completion of processing of a single data unit.

FIG. 2 is a block diagram of the power control unit 16. The power control unit 16 includes a controlled-voltage generating unit 161, a Jack Knife Flip-Flop (JK-FF) circuit 162, an OR circuit 163, a NAND circuit 164, an AND circuit 165, and a Toggle Flip-Flop (T-FF) circuit 166.

The controlled-voltage generating unit 161 includes a counter circuit 1611, a multiplier 1612, and a digital-to-analog converter (DA converter) 1613. The counter circuit 1611 has a register which stores a counter value. While the counter circuit 1611 receives an input of “1” at an input port VALID, the counter circuit 1611 performs counting-up or counting-down according to an input to an input port SIGN. For example, if “1” is input to the SIGN, the counter circuit 1611 increments the counter value stored therein; whereas if “0” is input to the SIGN, the counter circuit 1611 decrements the counter value. The counter value is associated with the value of voltage supplied to the processing block 13. An amount of the voltage or power corresponding to the counter value is supplied to the processing block 13.

The multiplier 1612 multiplies the counter value output from the counter circuit 1611 by a coefficient α. The DA converter 1613 converts the multiplied value to an analog signal, and outputs it as a REGIN signal. The coefficient α is assumed herein to be stored in a storage device such as a register (not shown) in advance, and to be read by the multiplier 1612 each time. The coefficient α can be acquired in other modes. For example, it can be received from an external control processor.

The TRG 1 and the TRG 2 are transmitted, as shown in FIG. 2, through the JK-FF circuit 162 to the SIGN port of the counter circuit 1611, or through the OR circuit 163, the NAND circuit 16 4, the AND circuit 165, and the T-FF circuit 166 to the VALID port of the counter circuit 1611.

A signal input to the SIGN port of the counter circuit 1611 is determined based on the TRG 1 being input to a J port of the JK-FF circuit 162 and the TRG 2 being input to a K port of the JK-FF circuit 162. If a pulse signal is input as the TRG 1 first, the JK-FF circuit 162 outputs “1” to the SIGN port; whereas if a pulse signal is input as the TRG 2 first, the JK-FF circuit 162 outputs “0” to the SIGN port.

A signal input to the VALID port of the counter circuit 1611 is determined based on the TRG 1 and the TRG 2 passing through a logic circuit from the OR circuit 163 to the T-FF circuit 166 shown in FIG. 2. The logic circuit is configured to switch a counter signal between ON and OFF every time a pulse signal of the TRG 1 or the TRG 2 is generated.

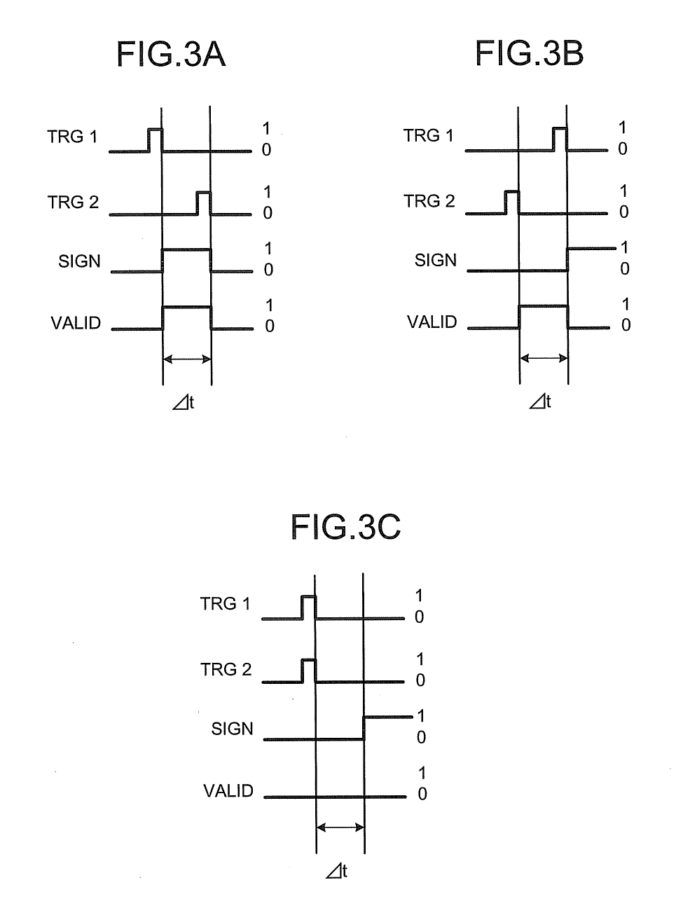

For example, if the pulse signal occurs to the TRG 1 at first as shown in FIG. 3A, the SIGN input attains “1”, and the VALID input is retained at “1” during a time period At between the pulse signal in the TRG 1 and the pulse signal in the TRG 2. The counter value is kept being incremented during the time period. On the contrary, in an example shown in FIG. 3B, the SIGN input remains “0” during the time period At between the pulse signal in the TRG 2 and the pulse signal in the TRG 1, and attains “1” after the input of the pulse signal in the TRG 1; however, the VALID input attains “1” only during the time period. Therefore, the counter value is kept being decremented only during this time period. In an example shown in FIG. 3C, the TRG 1 and the TRG 2 are pulsed at the same time. In this case, the counter value does not change because the VALID remains “0” though the value of the SIGN changes.

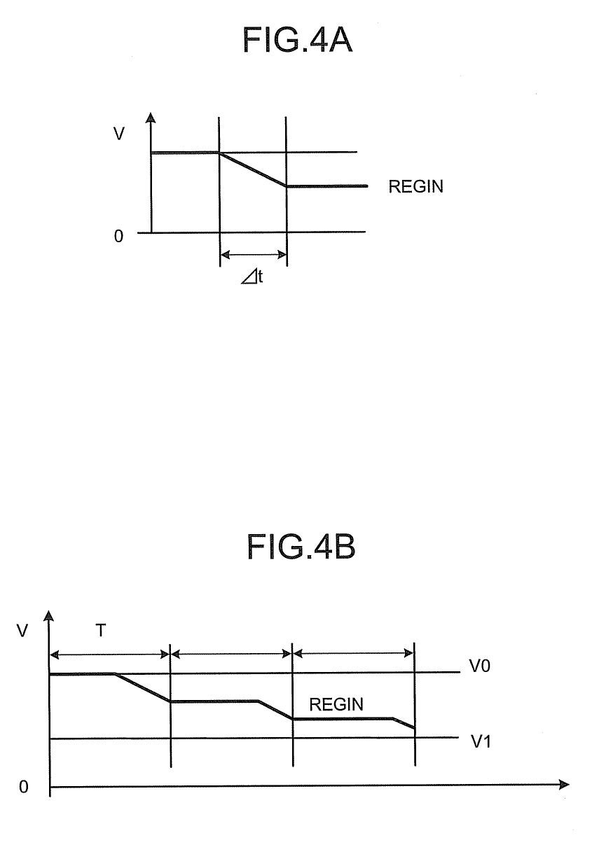

Specifically, the controlled-voltage generating unit 161 sets the time period Δt to an amount (time) corresponding to an integration value of a VALID signal while the VALID attains “1”. The controlled-voltage generating unit 161 acquires the value of the SIGN in the time period Δt, whereby determining which one of the processing block 11 and the processing block 13 performed the process faster. For example, if the SIGN indicates “0”, the processing block 13 performs the process faster, and the controlled-voltage generating unit 161 decrements the counter value in the direction of reducing the voltage. In this case, the value output from the counter circuit 1611 is processed by the multiplier 1612 and the DA converter 1613, and then output as the REGIN in the waveform as shown in FIG. 4A. By repeating the same operation for a plurality of cycles as shown in FIG. 4B, the controlled-voltage generating unit 161 can reduce the voltage from a voltage V at the time of starting the operation to a target voltage V1. On the other hand, if the processing block 11 performs the process faster, the controlled-voltage generating unit 161 increments the counter value in the direction of increasing the voltage.

The coefficient α means a controlled amount predetermined according to the operational specification of the voltage-controlled power supply 17, and the time until the voltage value stabilizes is shortened by increasing α. On the contrary, if α is reduced, the time until the voltage value stabilizes is extended.

As described above, the synchronization control apparatus 1 according to the first embodiment determines the amount of power for the processing block 13 according to the time difference between inputting the TRG 1 from the processing block 11 and inputting the TRG 2 from the processing block 13, and supplies the determined amount of the power to the processing block 13. As a result, the synchronization control apparatus 1 synchronizes the operation of the processing block 13 with that of the processing block 11, which is the standard, without making the buffer size redundant regardless of the variation caused by variations in the process parameter or the temperature. Moreover, the process to be performed by cooperation between the processing block 11 and the processing block 13 can be made more efficient.

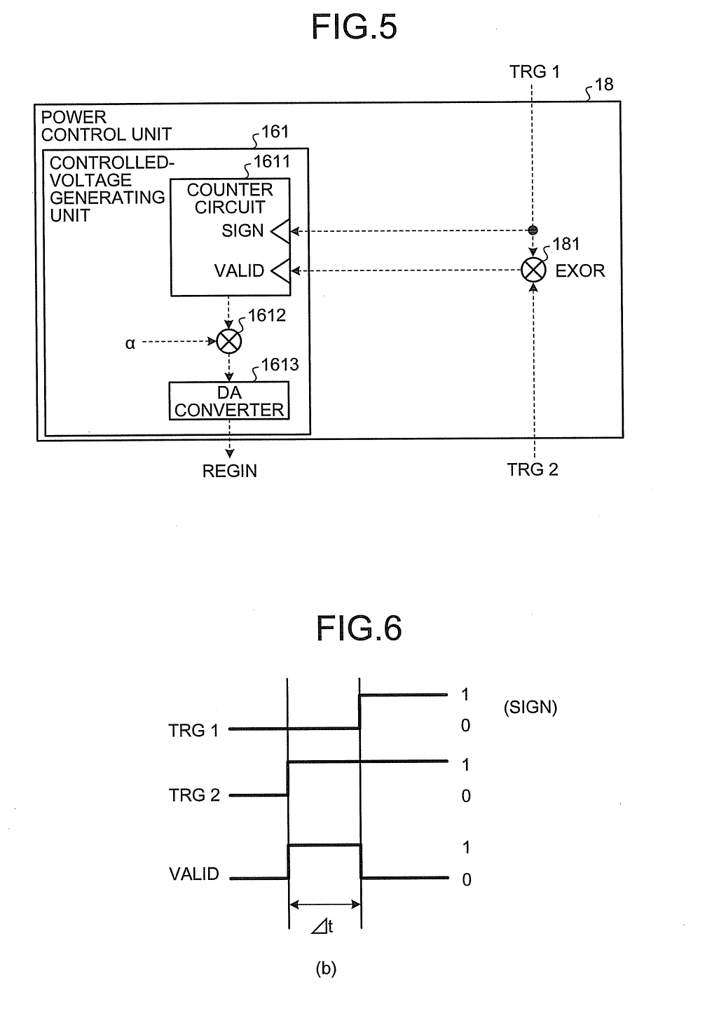

Although the power control unit 16 according to the first embodiment includes the logic circuit shown in FIG. 2, the configuration of the power control unit 16 is not limited thereto. For example, the power control unit 16 can be configured as shown in FIG. 5. A modification of the power control unit 16 is explained below as a power control unit 18 with reference to FIG. 5.

FIG. 5 is a block diagram of the power control unit 18. As shown in FIG. 5, the power control unit 18 includes an EXOR circuit 181 instead of the logic circuit shown in FIG. 2. According to a first modification of the first embodiment, the processing block 11 and the processing block 13 are configured to switch the pulsed state of the TRG 1 and the TRG 2 from negation (0) to assertion (1) when the DATA 1 and the DATA 2 are generated or updated, and continuously output it until the next process.

As shown in FIG. 6, when the processing block 11 and the processing block 13 complete the predetermined process and update the DATA 1 and the DATA 2, respectively, the TRG 1 and the TRG 2 changes from “0” to “1”.

The EXOR circuit 181 computes an exclusive OR of the TRG 1 and the TRG 2, and outputs the computed result to the VALID port of the counter circuit 1611 as the VALID signal. For example, if the TRG 2 completes the process earlier than the TRG 1, the EXOR circuit 181 outputs the VALID signal in the waveform as shown in FIG. 6. The EXOR circuit 181 is configured to input the TRG 1 to the SIGN port of the counter circuit 1611 to be used as a code of the controlled voltage.

By configuring the power control unit 18 as described above, the circuitry used therein is simpler and smaller than that in the power control unit 16 shown in FIG. 2, whereby the production cost and power consumption can be reduced.

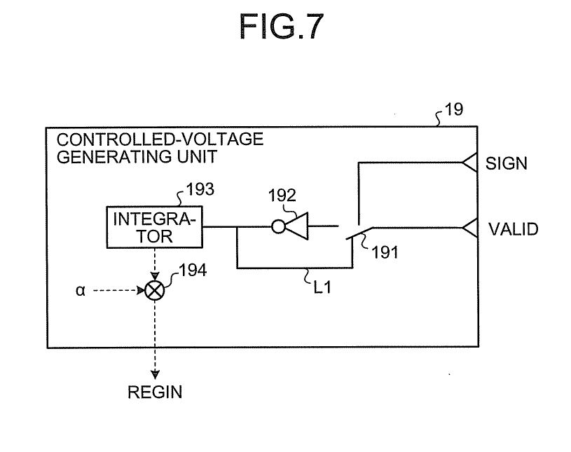

The controlled-voltage generating unit 161 can be configured as shown in FIG. 7. A modification of the controlled-voltage generating unit 161 is explained below as a controlled-voltage generating unit 19 with reference to FIG. 7.

FIG. 7 is a block diagram of the controlled-voltage generating unit 19 according to a second modification of the first embodiment. As shown in FIG. 7, the controlled-voltage generating unit 19 includes a switch 191, an inverter 192, an integrator 193, and a multiplier 194.

The switch 191 switches an output port for the signal input to the VALID according to the signal input to the SIGN, and connects it to one of an input port of the inverter 192 and an input port of a path L1 that bypasses the inverter 192. For example, if “0” is input to the SIGN, the switch 191 connects the output port for the signal input to the VALID to the input port of the inverter 192. The inverter 192 inverts the value of the input signal, and outputs the inverted signal to the integrator 193.

The integrator 193 outputs a different signal according to the input signal. For example, if the input signal value is positive, the integrator 193 outputs the signal that increases the voltage; whereas if the input signal value is negative, it outputs the signal that reduces the voltage. The multiplier 194 multiplies the signal output from the integrator 193 by α, and outputs the multiplied signal as the REGIN.

With the configuration described above, the function of the controlled-voltage generating unit 161 is realized only with analog circuits. Therefore, the size of the circuitry is smaller because the DA converter 1613 is not required, and the power consumption is reduced.

A synchronization control apparatus 2 according to a second embodiment of the present invention is explained below. The elements identical to those in the first embodiment are denoted by the same numerals, and the explanation thereof is not repeated.

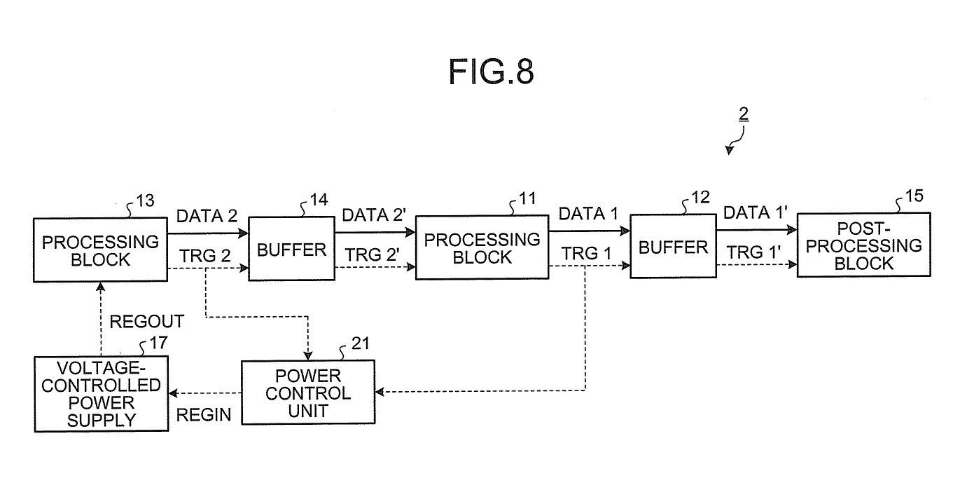

FIG. 8 is a block diagram of the synchronization control apparatus 2 according to the second embodiment. The synchronization control apparatus 2 is configured with same elements as those in the first embodiment except a power control unit 21. The synchronization control apparatus 2 is different from that of the first embodiment in that the processing block 11 processes signals based on the data processed by the processing block 13. More specifically, the processing block 11 receives the DATA 2′ from the buffer 14 according to the trigger signal TRG 2′, performs a predetermined process thereon, and outputs the DATA 1 resulting from the process to the buffer 12 along with the trigger signal TRG 1.

In FIG. 8, the processing block 11 processes the DATA 2′ processed by the processing block 13; however, there is a temporal restriction to the process performed by the processing block 11 and the processing block 13. Therefore, the data to be processed by the processing block 11 and the processing block 13 are temporally associated with operations of the processing block 11 and the processing block 13, and naturally related to synchronization between the processing block 11 and the processing block 13. The data to be processed by the processing block 13 is input from an external circuit (not shown) to the processing block 13.

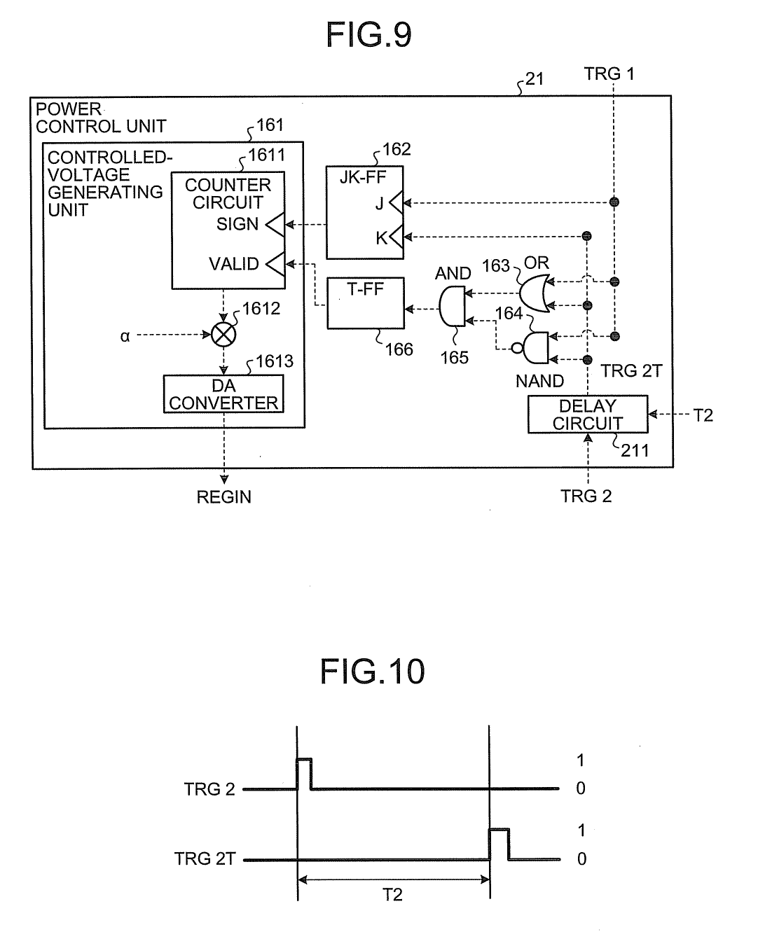

FIG. 9 is a block diagram of the power control unit 21. The power control unit 21. is equivalent to the power control unit 16 shown in FIG. 2 except that a delay circuit 211 is added.

The delay circuit 211 receives the TRG 2 from the processing block 13 and a delay time T2 to be described later as inputs, and operates so as to delay an input timing of the TRG 2 by the time corresponding to T2, as shown in FIG. 10. The delay circuit 211 then outputs the delayed TRG 2 as a TRG 2T to the JK-FF circuit 162, the OR circuit 163, and the NAND circuit 164.

The delay time T2 can be a signal that specifies the delay time by the delay circuit 211 and stored in the delay circuit 211 in advance, or it can be input from an external control device or the like. The delay time specified by T2 is desirably based on the connecting point between the processing block 11 and the processing block 13 and the timing of processes performed by the processing block 11 and the processing block 13, so that the processes are efficiently performed.

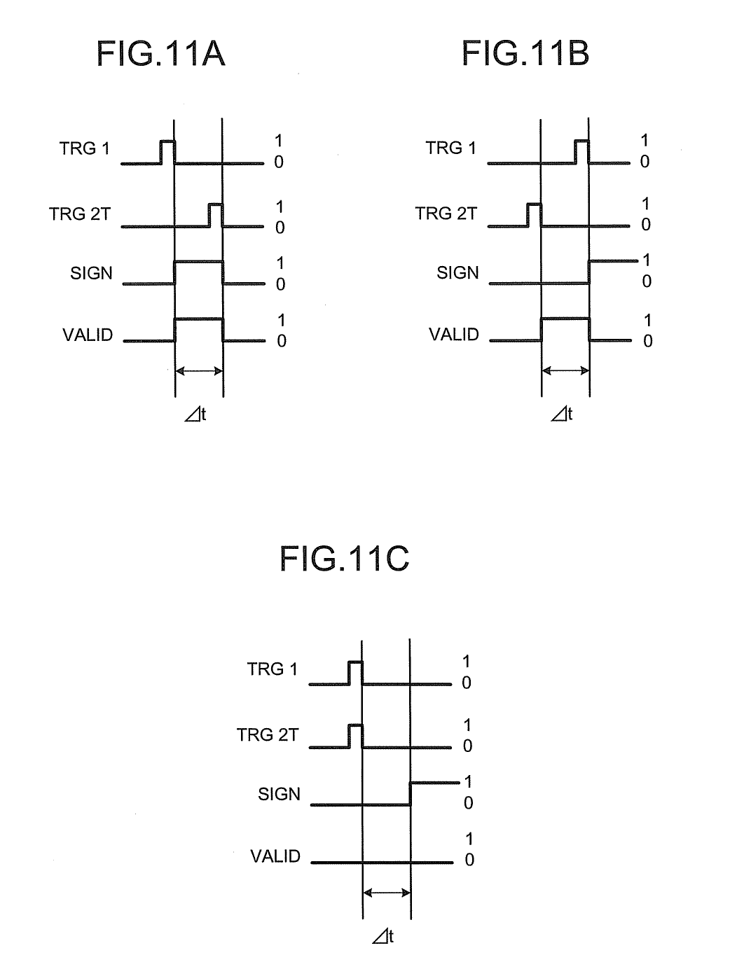

The TRG 2T output from the delay circuit 211 is processed in the same manner as the TRG 2 shown in FIG. 2, and, if the TRG 2T outputs the pulse signal after the TRG 1, a signal shown in FIG. 11A is output to the SIGN and VALID of the controlled-voltage generating unit 161. If the TRG 1 outputs the pulse signal after the TRG 2T, a signal shown in FIG. 11B is output to the SIGN and VALID of the controlled-voltage generating unit 161. If the TRG 1 and the TRG 2T output the pulse signal at the same time, a signal shown in FIG. 11C is output to the SIGN and VALID of the controlled-voltage generating unit 161.

The value output from the counter circuit 1611 is processed by the multiplier 1612 and the DA converter 1613, and then output as the REGIN in the waveform as shown in FIG. 4A. By repeating the same operation for a plurality of cycles as shown in FIG. 4B, the controlled-voltage generating unit 161 can reduce the voltage from the voltage V at the time of starting the operation to the target voltage V1.

As described above, the synchronization control apparatus 2 according to the second embodiment determines the amount of power for the processing block 13 according to the time difference between inputting the TRG 1 from the processing block 11 and inputting the TRG 2 from the processing block 13, and supplies the determined amount of the power to the processing block 13. As a result, the synchronization control apparatus 2 synchronizes the operation of the processing block 13 with that of the processing block 11, which is the standard, without making the buffer size redundant regardless of the variations caused by changes in the process parameter or the temperature. Moreover, the process to be performed by cooperation between the processing block 11 and the processing block 13 can be made more efficient.

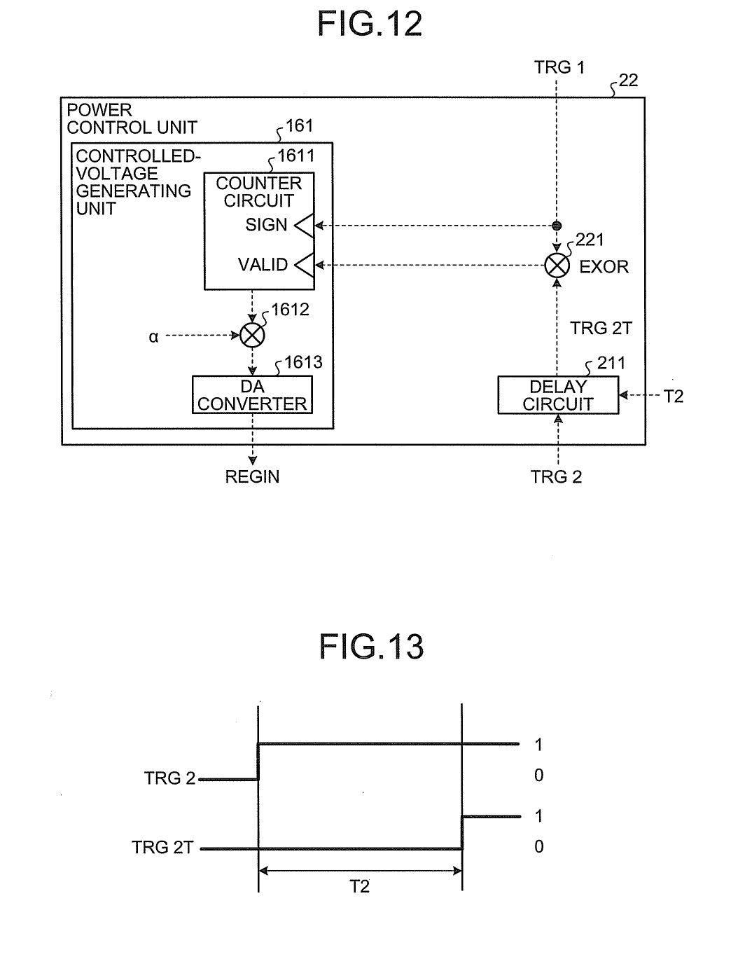

Although the power control unit 21 according to the second embodiment includes the logic circuit shown in FIG. 9, the configuration of the power control unit 21 is not limited thereto. For example, the power control unit 21 can be configured as shown in FIG. 12. A modification of the power control unit 21 is explained below as a power control unit 22 with reference to FIG. 12.

FIG. 12 is a block diagram of the power control unit 22. The power control unit 22 includes an EXOR circuit 221 instead of the logic circuit shown in FIG. 9. According to a first modification of the second embodiment, the processing block 11 and the processing block 13 are configured to switch the pulsed state of the TRG 1 and the TRG 2 from negation (0) to assertion (1) when the DATA 1 and the DATA 2 are generated or updated, and output it.

When the processing block 11 and the processing block 13 complete the predetermined process and update the DATA 1 and the DATA 2, respectively, the TRG 1 and the TRG 2 changes from “0” to “1”.

The delay circuit 211 delays the input timing of the TRG 2 by the amount of T2 as shown in FIG. 13, and outputs the resulting TRG 2T to the EXOR circuit 221.

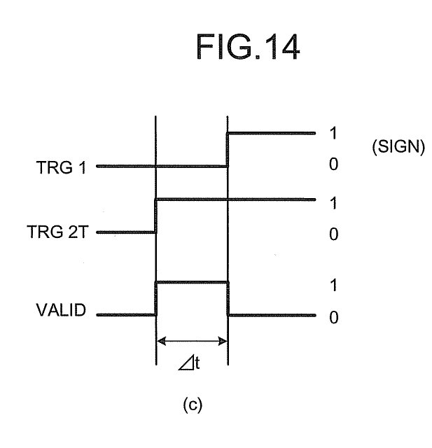

The EXOR circuit 221 computes an exclusive OR of the TRG 1 and the TRG 2T, and outputs the computed result to the VALID port of the counter circuit 1611 as the VALID signal. For example, if the TRG 2T completes the process earlier than the TRG 1, the EXOR circuit 221 outputs the VALID signal in the waveform as shown in FIG. 14. The EXOR circuit 221 is configured to input the TRG 1 to the SIGN port of the counter circuit 1611 to be used as a code of the controlled voltage.

By configuring the power control unit 22 as described above, the circuitry used therein is simpler and smaller than that in the power control unit 21 shown in FIG. 9, whereby the production cost and power consumption can be reduced.

The synchronization control apparatus 2 can be applied to various applications. Specific applications of the synchronization control apparatus 2 are explained below.

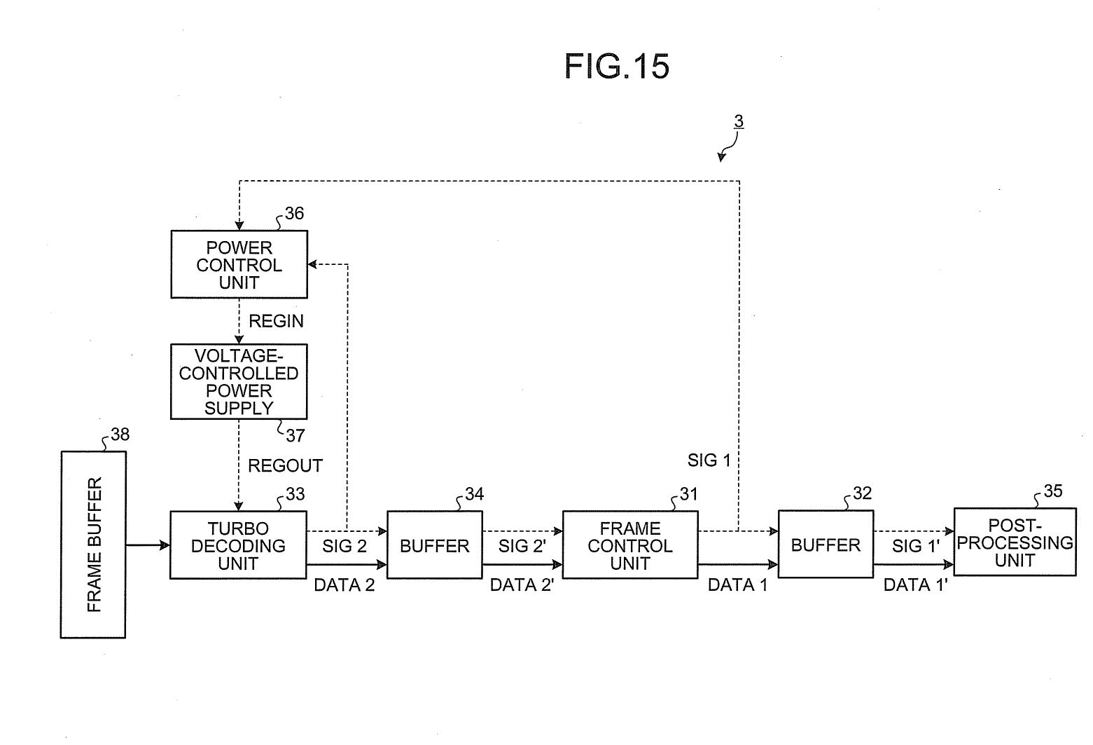

FIG. 15 is a block diagram of a frame processor 3 that uses the synchronization control apparatus 2. The frame processor 3 is used in a wireless communication system and the like, and performs a predetermined process with respect to each frame data in a predefined frame time.

The frame processor 3 includes a frame control unit 31 corresponding to the processing block 11, a buffer 32 corresponding to the buffer 12, a turbo decoding unit 33 corresponding to the processing block 13, a buffer 34 corresponding to the buffer 14, a post-processing unit 35 corresponding to the post-processing block 15, a power control unit 36 corresponding to the power control unit 21, a voltage-controlled power supply 37 corresponding to the voltage-controlled power supply 17, and a frame buffer 38.

The frame buffer 38 stores therein a plurality of the frame data to be processed. It is assumed that the frame data has been turbo-coded by an encoder (not shown), and the frame buffer 38 stores therein the turbo-coded data.

The turbo decoding unit 33 performs turbo-decoding on a group of the data in the frame buffer 38. The turbo decoding unit 33 outputs the resulting DATA 2 to the buffer 34, and outputs a trigger signal SIG 2 corresponding to the TRG 2 to the buffer 34 and the power control unit 36. The SIG 2 indicates that the DATA 2 is new data.

Upon receiving the SIG 2 from the turbo decoding unit 33, the buffer 34 stores therein the DATA 2 input with the SIG 2 as the DATA 2′ until it receives the next SIG 2. The buffer 34 outputs a trigger signal SIG 2′ to the frame control unit 31 every time the DATA 2′ is updated to inform the fact that a new DATA 2′ is stored in the buffer 34.

The frame control unit 31 controls the decoded DATA 2′ by converting it to a media access control (MAC) frame and the like. The frame control unit 31 outputs the resulting DATA 1 to the buffer 32, and outputs a trigger signal SIG 1 corresponding to the TRG 1 to the buffer 32 and the power control unit 36. The SIG 1 indicates that the DATA 1 is new data.

Upon receiving the SIG 1 from the frame control unit 31, the buffer 32 stores therein the DATA 1 input with the SIG 1 as the DATA 1′ until it receives the next SIG 1. The buffer 32 outputs a trigger signal SIG 1′ to the post-processing unit 35 every time the DATA 1′ is updated to inform the fact that a new DATA 1′ is stored in the buffer 32.

When the TRG 1′ is updated, the post-processing unit 35 acquires the DATA 1′ from the buffer 32, performs a predetermined process or operation based on the DATA 1′, and then outputs the result to a higher-level layer or an application layer (not shown).

For an efficient process with the configuration described above, operations of the turbo decoding unit 33 and the frame control unit 31 need to be synchronized at a predetermined timing. An operation of the power control unit 36 that relates to controls of the operations of the turbo decoding unit 33 and the frame control unit 31 is explained below.

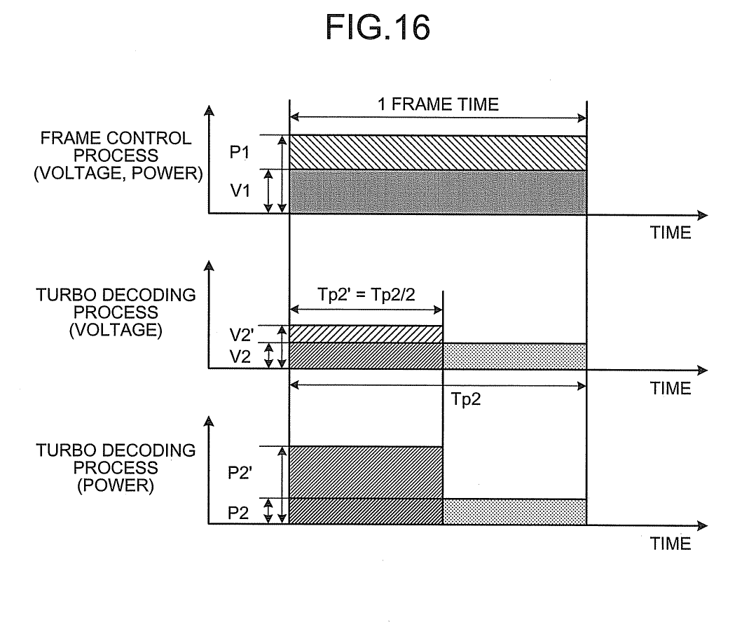

A voltage value to be supplied to the frame control unit 31 is assumed to be set in advance so that it operates in a single frame time. The voltage V1 and a power P1 in the frame control unit 31 is as shown in a graph at the top of FIG. 16. A processing time Tp2 for frame control is equivalent to a single frame time.

On the contrary, it is assumed that an initial voltage supplied to the turbo decoding unit 33 is V2′ and a processing time is Tp2′ in a graph in the middle of FIG. 16. It is also assumed that a power consumption of the turbo decoding unit 33 is P2′ and a processing time is Tp2′ in a graph at the bottom of FIG. 16.

It is also assumed that the frame control unit 31 performs a frame control process on a single frame to alter the SIG 1 from zero to one, and the turbo decoding unit 33 performs a turbo-decoding process on a single frame for Tp2′ to alter the SIG 2 from zero to one.

In such a case, the power control unit 36 determines the voltage to be applied to the turbo decoding unit 33 as V2 corresponding to a single frame time based on the difference of timings to acquire the SIG 1 and the SIG 2 from the frame control unit 31 and the turbo decoding unit 33, respectively (see the middle graph in FIG. 16).

As shown in the bottom graph in FIG. 16, as a result of the control by the power control unit 36, the voltage of the turbo decoding unit 33 is V2, and therefore, the power consumption is P2 and the processing time is Tp2 in the turbo decoding unit 33.

For example, it is assumed that the initial voltage V2′ is 1.2 volts and the controlled voltage V2 is 0.8 volt in the turbo decoding unit 33. Based on equations P2′=(V2′)², P2=(V2)², and Tp2′=Tp2/2, the ratio between the power consumptions in the initial state and after the control is represented by an equation (1), which indicates that the power consumption after the control is smaller than that in the initial state.

P2×Tp2/(P2′×Tp2′)=0.64×Tp2/(1.44×Tp2′)=1.28/1.44<1.0 (1)

In other words, according to the second embodiment, the turbo decoding unit 33 operates in association with the operating time of the frame control unit, and the power consumption of the turbo decoding unit 33 can be reduced.

A synchronization control apparatus 4 according to a third embodiment of the present invention is explained below. The elements identical to those in the first and second embodiments are denoted by the same numerals, and the explanation thereof is not repeated.

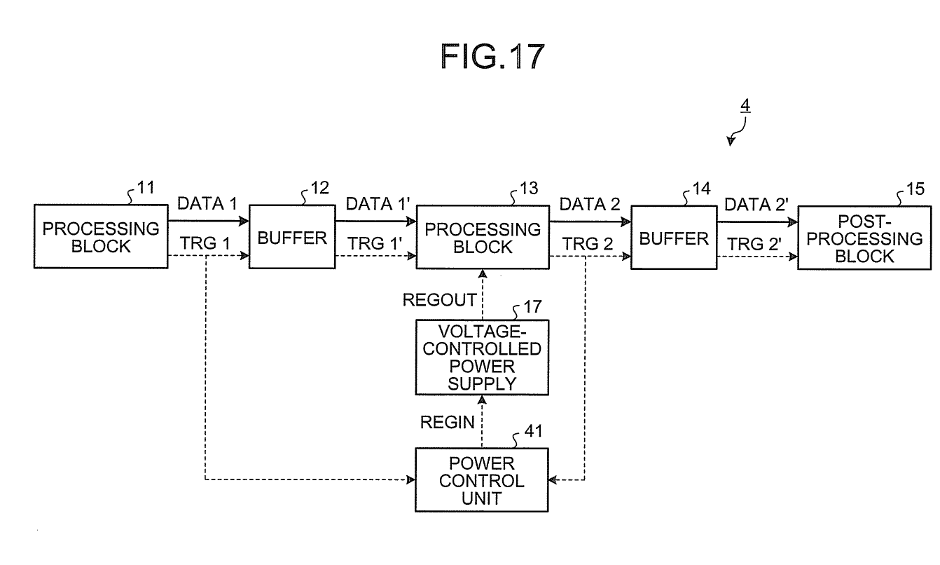

FIG. 17 is a block diagram of the synchronization control apparatus 4 according to the third embodiment. The synchronization control apparatus 4 is configured similarly to the synchronization control apparatus 2 shown in FIG. 8 except that positions of the processing block 11 and the processing block 13 are switched.

The processing block 13 processes the DATA 1′ that is processed by the processing block 11, and there is a temporal restriction to the process performed by the processing block 11 and the processing block 13. Therefore, the data to be processed by the processing block 11 and the processing block 13 are temporally associated with operations of the processing block 11 and the processing block 13, and naturally related to synchronization between the processing block 11 and the processing block 13. The data to be processed is input from an external circuit (not shown) to the processing block 11.

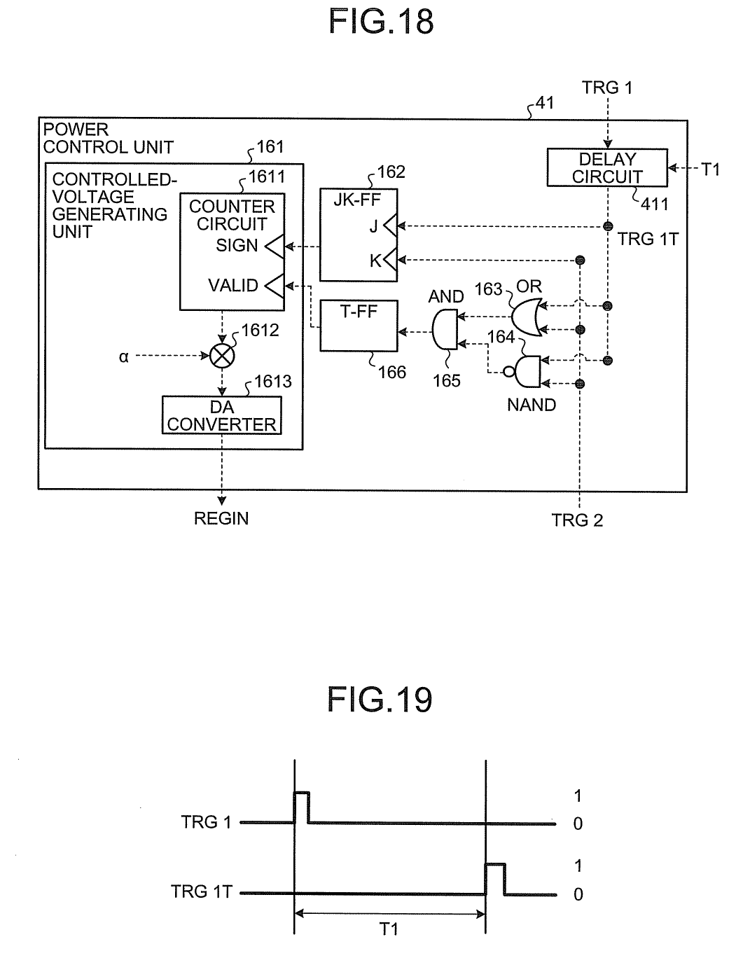

FIG. 18 is a block diagram of a power control unit 41 according to the third embodiment. The configuration of the power control unit 41 is equivalent to that of the power control unit 16 shown in FIG. 2 except that a delay circuit 411 is added.

As shown in FIG. 19, the delay circuit 411 operates so as to delay an input timing of the TRG 1 by a delay time T1 to be described later. The delay circuit 411 then outputs the delayed TRG 1 as a TRG 1T to the JK-FF circuit 162, the OR circuit 163, and the NAND circuit 164.

The delay time T1 can be a signal that specifies the delay time by the delay circuit 411 and stored in the delay circuit 411 in advance, or it can be input from an external control device or the like. The delay time specified by T1 is desirably based on the connecting point between the processing block 11 and the processing block 13 and the timing of processes performed by the processing block 11 and the processing block 13, so that the processes are efficiently performed.

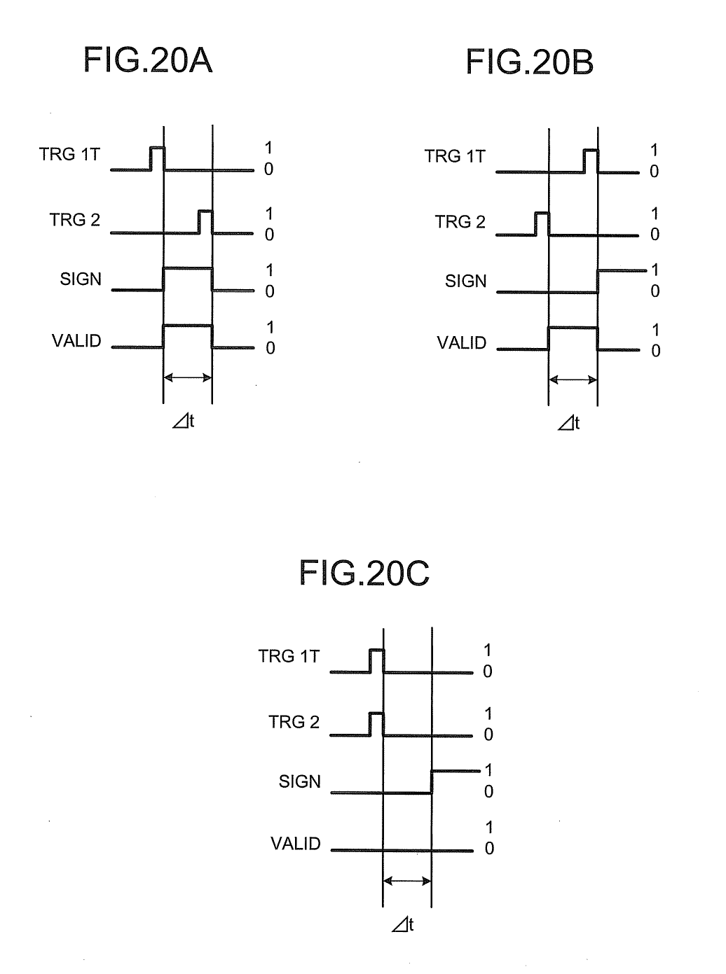

The TRG 1T output from the delay circuit 411 is processed in the same manner as the TRG 2 according to the first embodiment, and, if the TRG 1T outputs the pulse signal after the TRG 2, a signal shown in FIG. 20A is output to the SIGN and VALID of the controlled-voltage generating unit 161. If the TRG 2 outputs the pulse signal after the TRG 1T, a signal shown in FIG. 20B is output to the SIGN and VALID of the controlled-voltage generating unit 161. If the TRG 2 and the TRG 1T output the pulse signal at the same time, a signal shown in FIG. 20C is output to the SIGN and VALID of the controlled-voltage generating unit 161.

The value output from the counter circuit 1611 is processed by the multiplier 1612 and the DA converter 1613, and then output as the REGIN in the waveform as shown in FIG. 4A. By repeating the same operation for a plurality of cycles as shown in FIG. 4B, the controlled-voltage generating unit 161 can reduce the voltage from the voltage V at the time of starting the operation to the target voltage V1.

As described above, the synchronization control apparatus 4 according to the third embodiment determines the amount of power for the processing block 13 according to the time difference between inputting the TRG 1 from the processing block 11 and inputting the TRG 2 from the processing block 13, and supplies the determined amount of the power to the processing block 13. As a result, the synchronization control apparatus 4 synchronizes the operation of the processing block 13 with that of the processing block 11, which is the standard, without making the buffer size redundant regardless of the variations caused by changes in the process parameter or the temperature. Moreover, the process to be performed by cooperation between the processing block 11 and the processing block 13 can be made more efficient.

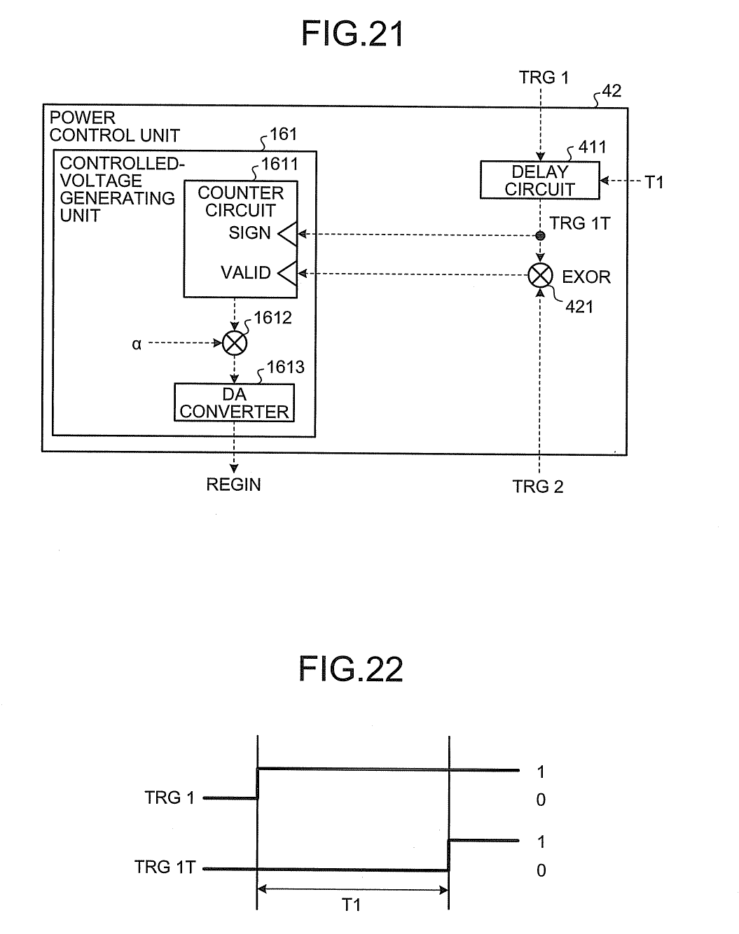

Although the power control unit 41 according to the third embodiment includes the logic circuit shown in FIG. 18, the configuration of the power control unit 41 is not limited thereto. For example, the power control unit 41 can be configured as shown in FIG. 21. A modification of the power control unit 41 is explained below as a power control unit 42 with reference to FIG. 21.

FIG. 21 is a block diagram of the power control unit 42. The power control unit 42 includes an EXOR circuit 421 instead of the logic circuit shown in FIG. 18. According to a first modification of the third embodiment, the processing block 11 and the processing block 13 are configured to switch the pulsed state of the TRG 1 and the TRG 2 from negation (0) to assertion (1) when the DATA 1 and the DATA 2 are generated or updated, and output it.

When the processing block 11 and the processing block 13 complete the predetermined process and update the DATA 1 and the DATA 2, respectively, the TRG 1 and the TRG 2 changes from “0” to “1”.

As shown in FIG. 22, the delay circuit 411 delays the input timing of the TRG 1 by the amount of T1, and outputs the resulting TRG 1T to the EXOR circuit 421.

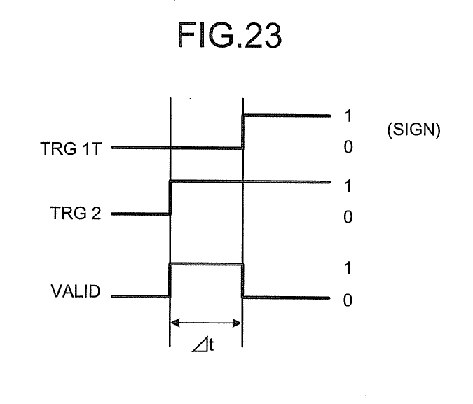

The EXOR circuit 421 computes an exclusive OR of the TRG 2 and the TRG 1T, and outputs the computed result to the VALID port of the counter circuit 1611 as the VALID signal. For example, if the TRG 1T completes the process earlier than the TRG 2, the EXOR circuit 421 outputs the VALID signal in the waveform as shown in FIG. 23. The EXOR circuit 421 is configured to input the delayed TRG 1T to the SIGN port of the counter circuit 1611 to be used as a code of the controlled voltage.

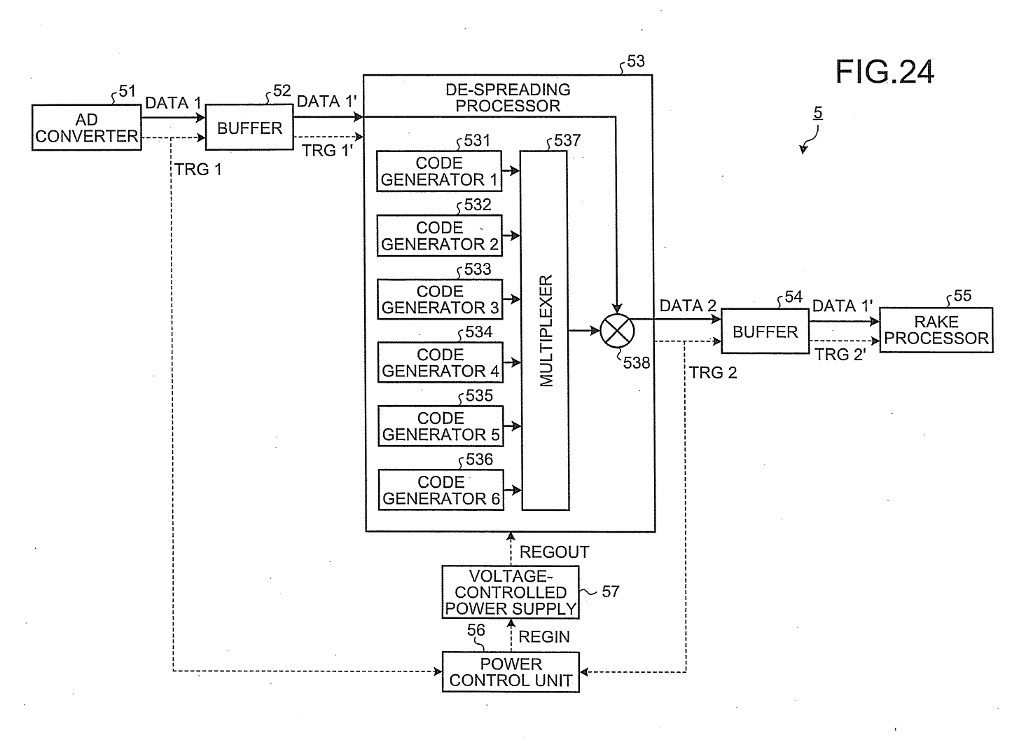

By configuring the power control unit 42 as described above, the circuitry used therein is simpler and smaller than that in the power control unit 41 shown in FIG. 18, whereby the production cost and power consumption can be reduced. The synchronization control apparatus 4 can be applied to various applications. Specific applications of the synchronization control apparatus 4 are explained below with reference to FIG. 24.

FIG. 24 is a block diagram of a de-spreading apparatus 5 that uses the synchronization control apparatus 4. The de-spreading apparatus 5 is used in a CDMA wireless communication system and the like. The de-spreading apparatus 5 generates a diffusion code at each of multipath timings, multiplies the diffusion code by received sampling data, and synthesizes the results by a RAKE process.

Because the multipath increases and decreases depending on the location and the mobile speed of the receiver, multiplication in a de-spreading is performed once per sample data if there is only one path. The number of multiplication increases in proportion to the number of paths if there is a plurality of paths. In other words, though the clock of the sampling data is constant, the number of processes increases in proportion to the number of the paths.

The de-spreading apparatus 5 includes an analog-to-digital converter (AD converter) 51 corresponding to the processing block 11, a buffer 52 corresponding to the buffer 12, a de-spreading processor 53 corresponding to the processing block 13, a buffer 54 corresponding to the buffer 14, a RAKE processor 55 corresponding to the post-processing block 15, a power control unit 56 corresponding to the power control unit 41, and a voltage-controlled power supply 57 corresponding to the voltage-controlled power supply 17.

The AD converter 51 converts a baseband signal from analog to digital, and generates the AD-converted data as the DATA 1. The AD converter 51 outputs the generated DATA 1 to the buffer 52, and outputs the trigger signal TRG 1 indicating that the DATA 1 is new data to the buffer 52 and the power control unit 56.

Upon receiving the TRG 1 from the AD converter 51, the buffer 52 stores therein the DATA 1 input with the TRG 1 as the DATA 1′ until it receives the next TRG 1. The buffer 52 outputs the trigger signal TRG 1′ to the de-spreading processor 53 every time the DATA 1′ is updated to inform the fact that a new DATA 1 is stored in the buffer 52.

The de-spreading processor 53 includes six code generators 531 to 536, a multiplexer 537, and a multiplier 538. Each of the code generators 531 to 536 generates an identical diffusion code at different timings, and outputs the generated diffusion code to the multiplexer 537. The de-spreading processor 53 operates only a certain number of the code generators 531 to 536 corresponding to the number of the paths to be received.

The multiplexer 537 sequentially selects the diffusion code generated in the code generators 531 to 536, and outputs it to the multiplier 538. The multiplier 538 multiplies the diffusion code supplied from the multiplexer 537 by the data in the buffer 52, and outputs the resulting data to the buffer 54 as the DATA 2.

Upon completion of the de-spreading process on the paths to be synthesized, the de-spreading processor 53 outputs the trigger signal TRG 2 indicative of the completion to the buffer 54 and the power control unit 56.

For example, to perform the de-spreading process on six paths, the de-spreading processor 53 repeats a series of processes six times, where each process includes generating the diffusion code for the DATA 1′ in the buffer 52 at a timing of each path in the code generators 531 to 536 and outputting the multiplication of the diffusion code and the data in the buffer 52 to the RAKE processor 55.

The buffer 54 stores therein the DATA 2 input from the de-spreading processor 53 as the DATA 2′. Upon receiving the TRG 2 from the de-spreading processor 53, the buffer 54 outputs the trigger signal TRG 2′ to the RAKE processor 55 to inform the fact that a new DATA 2′ is stored in the buffer 54.

Upon receiving the TRG 2′, the RAKE processor 55 acquires the DATA 2′ from the buffer 54, and synthesizes the DATA 2′ based on the delay in each path.

The power control unit 56 monitors the TRG 1 and the TRG 2, determines which one of the TRG 1 and the TRG 2 is updated earlier when both data are updated, and outputs the control signal REGIN corresponding to the time difference to the voltage-controlled power supply 57.

The voltage-controlled power supply 57 uses the REGIN as a reference signal, and supplies power to the de-spreading processor 53 with a voltage REGOUT specified by the REGIN. The REGOUT is determined in advance so that the time difference between the TRG 1 and the TRG 2 is equal to a predetermined value.

For example, if a number of receivable paths is changed to one, the processing time by the de-spreading processor 53 is reduced to approximately one-sixth; the power control unit 56 reads the change from the time difference between the TRG 1 and the TRG 2 and supplies the voltage-controlled power supply 57 with the REGIN; and the voltage-controlled power supply 57 changes the voltage supplied to the de-spreading processor 53 so as to meet the number of the paths, which is one, and reduces the processing speed.

To realize the same functions as described above using known technologies, the size of the buffer 54 needs to be large enough to store therein six samples according to the variation of the processing speed, which increases the size of the circuits. However, according to the third embodiment, the buffer 54 can be so small as to store a single sample. Therefore, the de-spreading apparatus 5 operates with an optimal voltage for the amount of the de-spreading process without making the buffer size redundant even in the multipath environment where the amount frequently fluctuates, and the power consumption can be reduced.

Although the explanation was given based on the embodiments described above, various modifications and improvements can be applied to the embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A synchronization control apparatus comprising:
a first processing block that performs a first process and outputs a first signal upon completion of the first process;
a second processing block that can change processing speed according to electric power supplied thereto, performs a second process associated with the first process out of synchronization with the first processing block, and outputs a second signal upon completion of the second process;
a control unit that determines an amount of the electric power to be supplied to the second processing block according to time difference between an input of the first signal and an input of the second signal; and
a supply unit that supplies the electric power in the amount determined to the second processing block.

2. The apparatus according to claim 1, wherein the control unit determines the amount of the electric power to be supplied to the second processing block so that the time difference is equal to a predetermined time based on a timing of inputting the first signal.

3. The apparatus according to claim 1, wherein
the first processing block and the second processing block individually process data temporally associated with each other, and
the control unit, if the first signal is input earlier than the second signal, increases the amount of the electric power depending on the time difference between the input of the first signal and the input of the second signal.

4. The apparatus according to claim 1, wherein
the first processing block and the second processing block individually process data temporally associated with each other, and
the control unit, if the second signal is input earlier than the first signal, decreases the amount of the electric power depending on the time difference between the input of the first signal and the input of the second signal.

5. The apparatus according to claim 1, further comprising an EXOR computing unit that computes an exclusive OR of an assertion period of the first signal and an assertion period of the second signal, wherein
the control unit uses an assertion period as a result of computing by the EXOR computing unit as the time difference between the input of the first signal and the input of the second signal.

6. The apparatus according to claim 1, wherein the first processing block and the second processing block are connected in parallel.

7. The apparatus according to claim 1, wherein the first processing block and the second processing block are connected in serial.

8. The apparatus according to claim 7, further comprising a delay unit that delays the timing of inputting one of the first signal and the second signal by a time corresponding to a connecting point between the first processing block and the second processing block.
